(19) United States
(12) Patent Application Publication
(10) Pub. No.: US 2024/0141721 A1
(43) Pub. Date: May 2, 2024

(54) Window Insert Installation Guidance System

(71) Applicant: Dean Golub, Chicago, IL (US)

(72) Inventor: Dean Golub, Chicago, IL (US)

(21) Appl. No.: 17/976,912

(22) Filed: Oct. 31, 2022

(51) Int. Cl. E06B 7/28

(52) U.S. Cl. CPC E06B 7/28

(57) ABSTRACT

A system which indicates correct installation of an insert within a common window opening.

This is a continuation-in-part of application Ser. No. 17/062,690 filed on Oct. 2, 2020 with title PORTABLE, COLLAPSIBLE, OPENED WINDOW MOUNTED ENCLOSURE WITH REDUNDANT FALL PREVENTION and naming Dean Golub as inventor the entire content of which is hereby incorporated herein by reference.

### BRIEF DESCRIPTION OF THE DRAWINGS

FIG. 22 Partial perspective view of present invention from slightly above and to the left of the invention as seen from indoors

FIG. 23 Partial perspective view of present invention from slightly below and to the right of the present invention as seen from outdoors

FIG. 24 Elevation view of present invention in an opened state

### DETAILED DESCRIPTION OF THE DRAWINGS

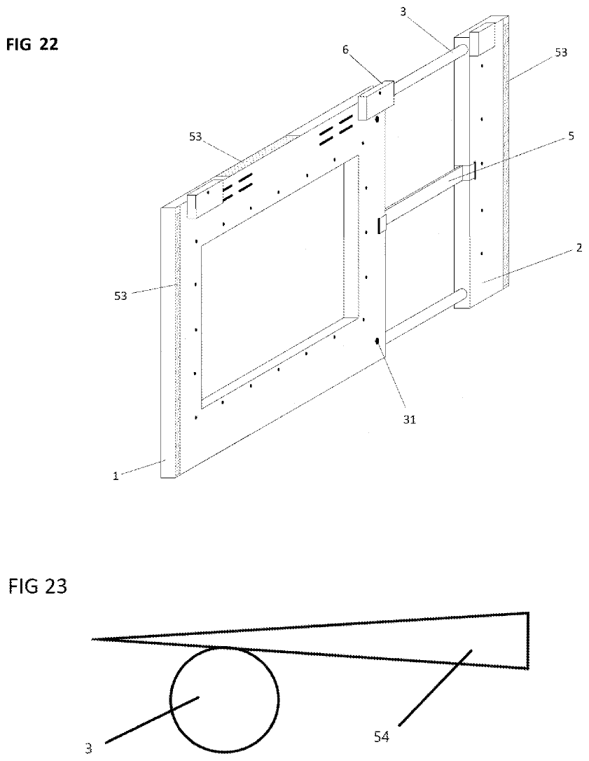

With regard to FIG. 22 which depicts a perspective view of the present invention. All parts of the invention not shown in FIG. 22 were deliberately omitted to show certain aspects of present invention. Flange 6 can be pivotally or flexibly mounted to frame 1 and have a non-cuboid shape. Frame 1 and frame extension 2 can have colored areas 53. Said colored areas 53 can display bright coloring such as fluorescent orange on the surfaces which come into contact with window sash 37 and window sash channels 34 providing the user a means to visually verify full engagement of frame 1 and frame extension 2 within a sash style opened window. Full engagement occurs when frame 1 is fully seated into one window sash channel 34, frame extension 2 is fully seated into the opposite window sash channel 34 from frame 1, the distance between frame 1 and frame extension 2 is fixed in a fully extended position within said sash channels, and window sash 37 is in contact with frame 1 and frame extension 2 within said sash style opened window. Full engagement of present invention within said sash style opened window obscures said colored areas 53. The absence of bright coloring visible to user would indicate full engagement of window sash channels 34 and window sash 37 within said sash style opened window. Frame 1 can have colored areas 53 elsewhere as indicum providing the user a means to visually verify correct attachment of external members to frame 1. Frame 1 can have a hole 31 which perpendicularly intersects with hole 31 in which frame extension rod 3 is seated providing a means to manually insert wedge 54 which frictionally engages frame extension rod 3 preventing said frame extension rod from sliding relative to frame 1. Frictionally engaging frame extension rod 3 with wedge 54 fixes the distance between frame 1 and frame extension 2 which provides a means to secure frame 1 and frame extension 2 into opposing window sash channels 34. Said wedge 54 which engages frame extension rod 3 can have grooves or barbs which provide tactile and audible means to indicate wedge 54 is fully engaged with frame extension rod 3. Frame 1 can have internal voids which accommodate internal objects such as springs, electronics, gears, cogs, and fasteners. Said electronics can be light emitting diodes, switches, and sound emitters which can provide aforementioned full engagement indicum.

With regard to FIG. 23 which depicts an elevation view of a certain aspect of the invention. Wedge 54 can have features which engages frame extension rod 3 differently dependent upon the position of said wedge in relation to frame extension rod 3. As said wedge is slid perpendicularly over the surface of said frame extension rod, resistance increases providing the user tactile indicum of maximum frictional contact with said frame extension rod. Wedge 54 can be conically shaped. Wedge 54 can have a cog or groove on the surface which contacts other parts of the invention which emits an audible sound and tactile signal as said wedge is slid over surface of said frame extension rod.

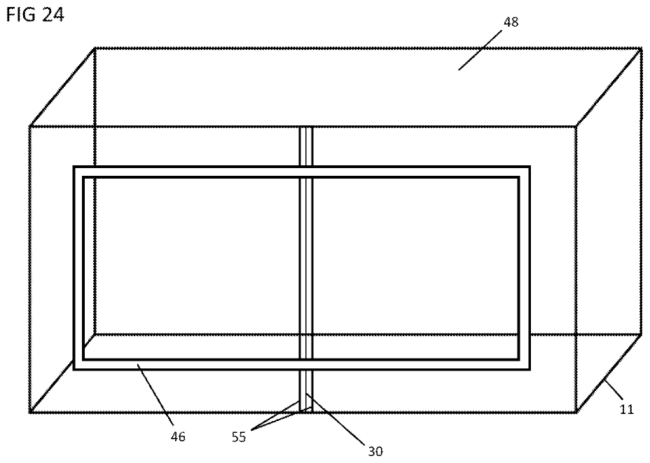

With regard to FIG. 24 which depicts a perspective view of enclosure 11. Another embodiment of enclosure 11 can be a closed cuboid shape comprising mesh screen material 48 which can support significant weight. One face of current embodiment can have a slot 30 centrally located between two edges of one said face. Parallel and adjacent on both sides of said slot can have individual strands of elastic material 55 interlaced through said mesh screen material 48 which approximate both sides of said slot together when said strands of elastic material are stretched longitudinally. The aforementioned configuration of said slot with said elastic material creates a self-closing slot which facilitates traversal of objects into and out of said enclosure. Current embodiment of enclosure can have barrier attachment strips 46 which have been attached together to create a rectangular shape of a predetermined size which can then be attached to said enclosure about said self-closing slot providing a means for attaching non-permeable material directly to enclosure.

### Glossary

53. Colored Area An area of a predetermined size distinguished from other areas by color or light.
54. Wedge A piece of a substance (such as wood or iron) that tapers to a thin edge and is used for tightening by being driven into something.
55. Elastic Material Any material which returns to original shape after being stretched.

17. An opened window mounted insert as defined in claim 16 further comprising:
a. brightly colored indicum at predetermined locations on surfaces of said insert which become obscured by said sash channels and said sash when said insert fully engages said opposing sash channels and said sash simultaneously.
b. at least one object having the ability to engage internal members of said insert and indicate maximum engagement of said internal members through tactile and audible means.
Whereby the user can verify full engagement of said insert within said opened window using visual, audible, and tactile means.

18. A means to indicate full engagement of a window insert within a common sash style window.
